(19) United States
(12) Patent Application Publication
(10) Pub. No.: US 2010/0190083 A1
(43) Pub. Date: Jul. 29, 2010

(54) SOLID OXIDE FUEL CELL UNIT FOR USE IN DISTRIBUTED POWER GENERATION

(76) Inventors: Jeroen Valensa, Muskego, WI (US); Michael Reinke, Franklin, WI (US); Michael McGregor, Racine, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 12/595,385

(22) PCT Filed: Apr. 17, 2008
(86) PCT No.: PCT/US08/60594

§ 371 Date: Mar. 2, 2010

Related U.S. Application Data
(60) Provisional application No. 60/923,863, filed on Apr. 17, 2007.

(51) Int. Cl. H01M 8/24

(52) U.S. Cl. 429/458; 429/456

(57) ABSTRACT

A fuel cell system includes a support structure, a reactant conditioning structure, a plurality of stacks of planar solid oxide fuel cells arranged on the support structure circumferentially around the reactant conditioning structure, and a flow path extending outwardly from the reactant conditioning structure to deliver reactants to the plurality of stacks.

### RELATED APPLICATIONS

This application claims priority of Provisional Patent Application No. 60/923,863 filed on Apr. 17, 2007, the contents of which are included herein by reference.

### FIELD OF THE INVENTION

The present invention relates to solid oxide fuel cells and reactant conditioning associated therewith.

### SUMMARY OF THE INVENTION

In some embodiments, the present invention provides a fuel cell unit having a centrally located reactant conditioning structure and a stack supporting structure to receive a plurality of planar solid oxide fuel cell stacks, the stacks being arranged around the periphery of the centrally located reactant conditioning structure, wherein the stack supporting structure includes a means to deliver one or more of the reactants from the reactant conditioning structure to the fuel cell stacks and/or from the fuel cell stacks to the reactant conditioning structure.

In some embodiments, the presentment invention provides a reactant conditioning structure comprising one or more annular cathode exhaust flow passages in heat exchange relation with one or more annular cathode feed flow passages to define a cathode recuperator.

In some embodiments, the presentment invention provides a reactant conditioning structure comprising an annular anode exhaust flow passage in heat exchange relation with an annular anode feed flow passage to define an anode recuperator.

In some embodiments, the presentment invention provides a reactant conditioning structure comprising an annular cathode feed flow passage in heat exchange relation with an annular anode exhaust flow passage to define a cathode air preheater/anode exhaust cooler. In a further feature, the exit of the cathode feed flow passage is connected to the inlet of a cathode feed flow passage for the cathode recuperator to allow a cathode feed to flow from the cathode air preheater/anode exhaust cooler to the cathode recuperator. The inlet of the anode exhaust gas flow passage can be connected to the exit of the anode exhaust flow passage for the anode recuperator to allow an anode exhaust gas to flow from the anode recuperator to the cathode air preheater/anode exhaust cooler.

In some embodiments, the presentment invention provides a radiant startup oxidizer provided along the outer periphery of the centrally located reactant conditioning structure, the radiant startup oxidizer enabling the heating up of the fuel cell stacks during startup of the fuel cell unit by transferring heat via radiation from the outer surface of the reactant conditioning structure to a plurality of fuel cell stacks surrounding and facing the outer surface.

In some embodiments, the presentment invention provides a reactant conditioning structure comprising a helical water flow passage located within an annular cathode exhaust flow passage to define a steam generator. The inlet of the annular cathode exhaust flow passage can be connected to the exit of a cathode exhaust flow passage for the cathode recuperator to allow a cathode exhaust gas to flow from the cathode recuperator to the steam generator.

In some embodiments, the presentment invention provides a reactant conditioning structure comprising an anode tailgas oxidizer (“ATO”) reactor to receive a flow comprised of cooled anode exhaust and air, and to oxidize the combustible species contained within the flow with the oxygen contained within the flow in order to produce a hot ATO exhaust gas.

In some embodiments, the presentment invention provides a reactant conditioning structure comprising an annular anode feed flow passage in heat exchange relation with an annular ATO exhaust flow passage to define an anode preconditioning heat exchanger. The exit of the anode feed flow passage can be connected to the inlet of the anode feed flow passage for the anode recuperator to allow an anode feed to flow from the anode preconditioning heat exchanger to the anode recuperator. The inlet of the ATO exhaust flow passage can be connected to the exit of the ATO to allow an ATO exhaust gas to flow from the ATO to the anode preconditioning heat exchanger. The annular anode feed flow passage can be comprised of a reformer catalyst coated surface to partially reform the anode feed as it passes through the anode preconditioning heat exchanger.

In some embodiments, the presentment invention provides a fuel cell unit further comprising a hotbox outer shell that mechanically attaches to the centrally located reactant conditioning structure and to the stack supporting structure in order to enclose the fuel cell stacks.

In some embodiments of the invention, a plurality of flow baffles are provided between the fuel cell stacks to define a cathode air inlet plenum between the outward-facing sides of the stacks and the inner surface of the hotbox outer shell, and the fuel cell stacks are provided with a plurality of cathode air inlet ports located on the outward-facing sides of the fuel cell stacks to receive a cathode air flow from the cathode air inlet plenum.

In some embodiments of the invention, the stack supporting structure is comprised of a plurality of stack support modules, each module comprising one or more anode feed channels, one or more anode exhaust channels and one or more cathode feed channels.

The invention also provides a fuel cell system including a support structure, a reactant conditioning structure, a plurality of stacks of planar solid oxide fuel cells arranged on the support structure circumferentially around the reactant conditioning structure, and a flow path extending outwardly from the reactant conditioning structure to deliver reactants to the plurality of stacks.

In some embodiments, the invention provides a fuel cell system including a support structure, a reactant conditioning structure, a plurality of stacks of planar solid oxide fuel cells arranged on the support structure circumferentially around the reactant conditioning structure, a first flow path extending outwardly from the reactant conditioning structure to transfer a first reactant between the reactant conditioning structure and the plurality of stacks, and second flow path extending outwardly from the reactant conditioning structure to transfer a second reactant between the reactant conditioning structure and the plurality of stacks.

In some embodiments, the invention provides a fuel cell system including a support structure, a reactant conditioning structure, a plurality of stacks of planar solid oxide fuel cells arranged on the support structure circumferentially around the reactant conditioning structure, and a flow path extending outwardly from the reactant conditioning structure to transfer a first reactant between the reactant conditioning structure and the plurality of stacks. The support structure includes a wedge shaped manifold supporting at least one of the plurality of stacks thereon.

In some embodiments, the invention provides a manifold of a fuel cell system. The manifold includes a first face for supporting a plurality of planar solid oxide fuel cells, a second face opposite to the first face, the second face at least partially defining an anode feed plenum and an anode exhaust plenum, an anode feed inlet extending between the first face and the second face and being fluidly connected to one end of the anode feed plenum, an anode flow outlet extending between the first face and the second face and being connected to one end of the anode exhaust plenum, a plenum inlet fluidly connected to another end of the anode feed plenum, a plenum outlet fluidly connected to another end of the anode exhaust plenum, and a cathode flow outlet opening through an exterior edge of the manifold to direct cathode offgas away from the plurality of planar solid oxide fuel cells, the exterior edge extending between the first surface and the second surface.

In some embodiments, the invention provides a fuel cell system including a fuel cell stack support structure, and a reactant conditioning apparatus to condition anode and cathode reactants within to a temperature and composition for optimal reaction within a plurality of solid oxide fuel cell stacks supported on the fuel cell stack support structure. The plurality of fuel cell stacks are in fluid communication with the reactant conditioning apparatus to direct preconditioned anode and cathode reactants to the fuel cell stacks and direct cathode and anode exhaust from the fuel cell stacks to the conditioning apparatus. The fuel cell stacks surround the conditioning apparatus.

In some embodiments, the invention provides a fuel cell system includes a support structure, a reactant conditioning apparatus mounted on the support structure and including an anode tailgas oxidizer, an anode feed preconditioning heat exchanger, an anode recuperator, an air preheater, a steam generator, a cathode recuperator, and a startup oxidizer, a plurality of cells supported on the structure so as to be removeable without disconnecting the elements of the conditioning apparatus, and a removable cover operable to enclose the plurality of cells and at least a portion of the conditioning apparatus.

In some embodiments, the invention provides a fuel cell system includes an integrated fuel cell stack support structure, a reactant conditioning apparatus mounted on the support structure and operable to condition anode and cathode reactants within to a temperature and composition for consumption within a plurality of solid oxide fuel cell stacks, and a flow manifold coupled to the reactant conditioning apparatus for delivering a substantially uniformly distributed combustible mixture to a startup oxidizer. The manifold structure is configured to receive a combustible flow comprising a fuel flow delivered through a startup oxidizer fuel inlet port and further comprising an air flow delivered through a startup oxidizer air inlet port. A flow velocity of the mixture within the flow manifold is maintained greater than a laminar flame speed of the mixture in order to avoid pre-ignition of the combustible mixture.

Other objects, features and advantages of the invention will become apparent from a review of the entire specification and appended drawings.

### BRIEF DESCRIPTION OF THE DRAWINGS

FIG. 1 is a perspective view showing an integrated fuel cell support structure and reactant conditioning apparatus of a fuel cell unit embodying the present invention.

FIG. 2 is an enlarged view showing a portion of FIG. 1 in greater detail.

FIG. 3 is a perspective view of a stack support module for use in the unit of FIG. 1.

FIG. 4 is another perspective view of the stack support module of FIG. 3 showing several internal details.

FIG. 5 is a partial section view of the unit of FIG. 1 showing the locations of several components within the reactant conditioning apparatus.

FIG. 6 is an enlarged view showing a portion of FIG. 5 in greater detail.

FIG. 7 is a perspective view of a steam generator coil for use in the unit of FIG. 1.

FIG. 8 is a perspective view showing the unit of FIG. 1 with a hotbox outer shell assembled.

FIG. 9 is a sectional view taken from line 9-9 in FIG. 8.

FIG. 10 is a plan view showing the flow paths through a startup oxidizer flow distribution manifold for use in the unit of FIG. 1.

FIG. 11 is a perspective view showing a portion of a stack compression mechanism equipped fuel cell unit embodying the present invention.

FIG. 12 is an enlarged partial section view showing certain details of the stack compression mechanism of the unit of FIG. 11.

FIG. 13 is a schematic representation of the fuel cell unit.

Other aspects of the invention will become apparent by consideration of the detailed description and accompanying drawings.

### DETAILED DESCRIPTION OF THE PREFERRED EMBODIMENTS

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

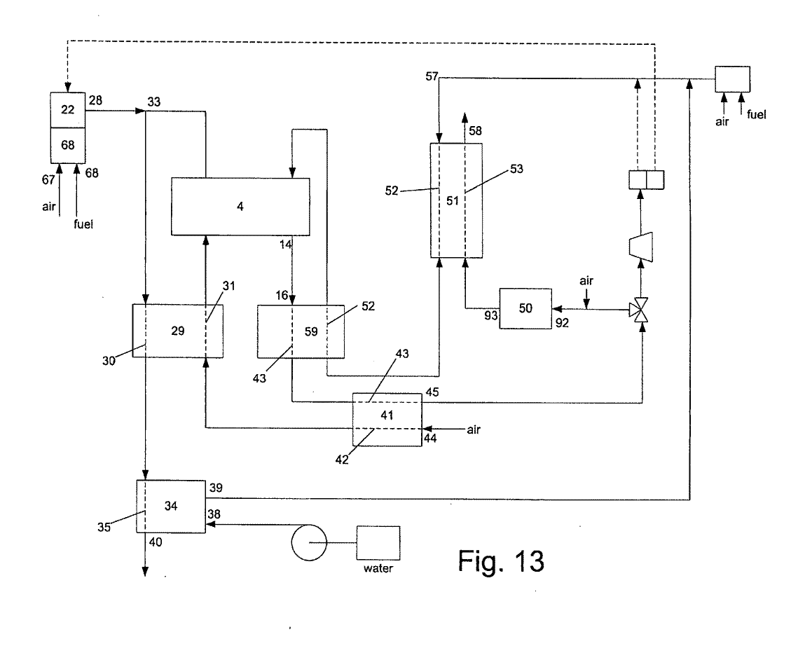

FIGS. 1-13 depict portions of a fuel cell system 1 according to some embodiments of the present invention. The fuel cell system 1 is comprised of an integrated fuel cell stack support structure 3 and a centrally located reactant conditioning apparatus 2. The system 1 is configured to receive a cold fresh cathode air feed through an air inlet port 44 located on the centrally located reactant conditioning apparatus 2, and to receive a cold anode feed through an anode inlet port 57 located on the centrally located reactant conditioning apparatus 2. In some embodiments, the cold anode feed may be comprised of steam and a gaseous hydrocarbon fuel such as natural gas, methane, propane or other commonly known gaseous hydrocarbon fuels. In some embodiments, the cold anode feed may be comprised of a hydrocarbon fuel and a recycled anode offgas comprising hydrogen, water vapor, and carbon monoxide. The anode and cathode reactants are conditioned within the centrally located reactant conditioning apparatus 2 to a temperature and composition appropriate for consumption within a plurality of planar solid oxide fuel cell stacks 4, and are delivered to the fuel cell stack support structure 3.

The fuel cell stack support structure 3 is comprised of a low-temperature support base 5, a high-temperature sealing surface 6, a thermally insulating layer 7, and a plurality of stack support modules 10. The fuel cell stack support structure 3 includes a plurality of electrode pass-through holes 62 which penetrate through the sealing surface 6, the insulation 7, and the low-temperature base 5 in order to provide a means for electrical current conducting electrodes to convey an electrical current to and from the plurality of fuel cell stacks 4.

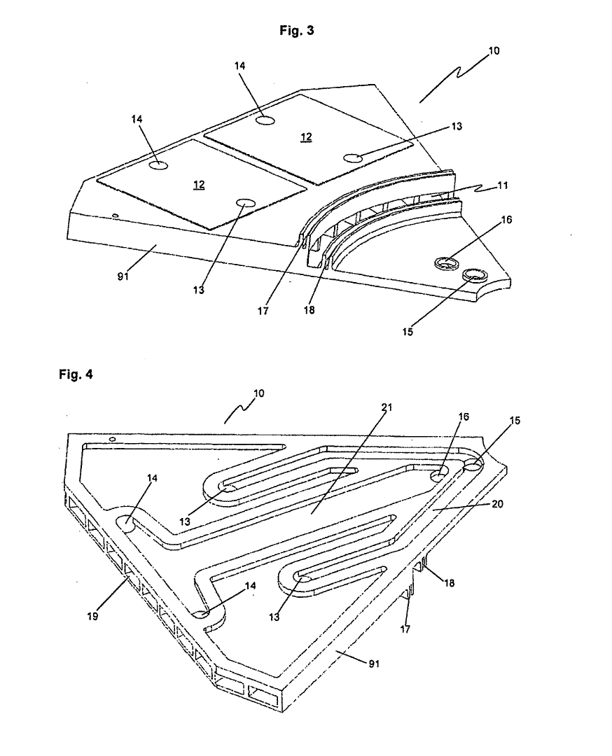

With reference to FIGS. 3 and 4, the stack support modules 10 will be explained in greater detail. The stack support modules 10 include a stack mounting surface 12 configured as a surface on which one or more fuel cell stacks 4 can be supported. It should be appreciated by those skilled in the art that a gasket or seal may be included between the stack mounting surface 12 and the one or more fuel cell stacks 4. Penetrating the stack mounting surface 12 are one or more anode inlet ports 13 to deliver a pre-conditioned anode flow to the one or more fuel cell stacks 4, and one or more anode exit ports 14 to receive an anode offgas flow from the one or more fuel cell stacks 4. The one or more anode inlet ports 13 are connected to an anode feed plenum 20 located within the stack support module 10, and the one or more anode exit ports 14 are connected to an anode exhaust plenum 21 located within the stack support module 10. The stack support module 10 further includes an anode manifold inlet port 15 connected to the anode feed plenum 20, and an anode manifold exit port 16 connected to the anode exhaust plenum 21.

The stack support modules 10 further include a first circular groove 17 and a second circular groove 18 concentric to and smaller in radius than the first circular groove 17. It should be observed that in the embodiment shown the stack support modules 10 exhibit a wedge shape, with a pair of non-parallel symmetrical side surfaces 91 that, if extended to the point of intersection, would intersect at a line approximately corresponding to the axis of the circular grooves 17 and 18. The stack mounting surface 12 is located radially outward of the first circular groove 17, and the manifold inlet port 15 and manifold exit port 16 are located radially inward of the second circular groove 18.

The stack support modules 10 further include a plurality of cathode air passages 11, configured to provide a flow path open at one end to the space between the first circular groove 17 and second circular groove 18, and open at the other end to a plurality of cathode air passage exits 19. While the embodiment shown in FIG. 4 depicts an orientation of the cathode air passage exits 19 that is approximately radial with respect to the concentric circular grooves 17 and 18, it should be understood that the preferred orientation of the cathode air passage exits 19 may depend on specific features of the fuel cell stacks 4. As an example, an embodiment wherein the cathode air passage exits 19 are located on the stack mounting surface 12 has been contemplated as being preferable for use with fuel cell stacks 4 that exhibit an internally manifolded cathode.

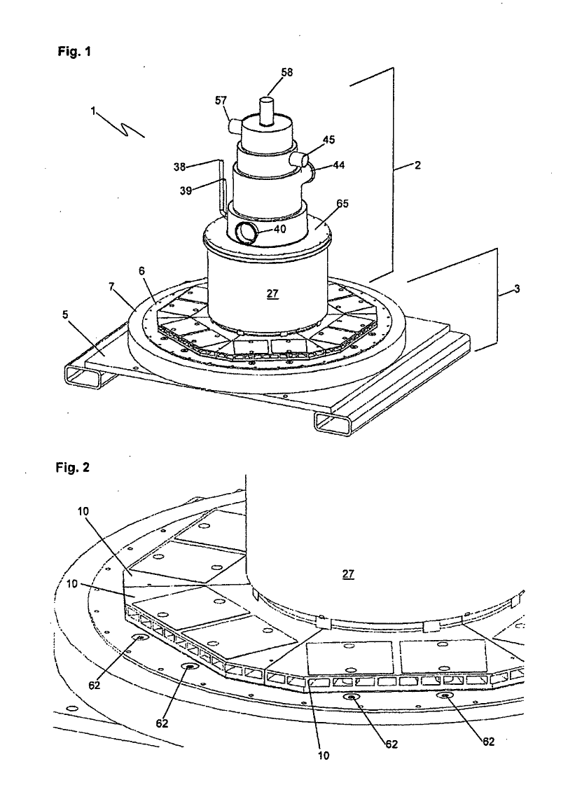

As best shown in FIG. 2, the plurality of stack support modules 10 are arranged so that the side surfaces 91 of each of the modules 10 are approximately in contact with the side surfaces 91 of the adjacent modules 10.

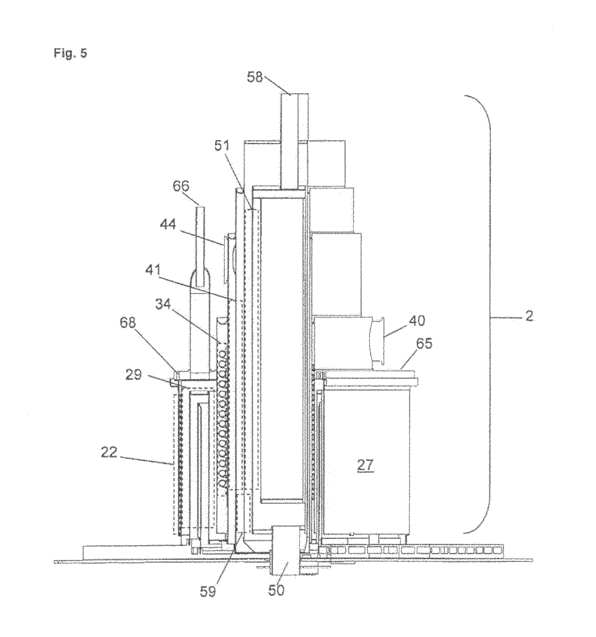

The internal details of an embodiment of the centrally located reactant conditioning apparatus 2 will now be explained in greater detail, with particular reference made to FIGS. 5-7. The reactant conditioning apparatus shown comprises: an air preheater 41; a steam generator 34; a cathode recuperator 29; a startup oxidizer 22; an anode recuperator 59; an anode tailgas oxidizer (“ATO”) 50; and an anode feed preconditioning heat exchanger 51.

The air preheater 41 is comprised of a first annular flow channel 42, a second annular flow channel 43 located concentric to and radially inward of the first annular flow channel 42, and a thermally conductive separating cylinder 46 located between the first channel 42 and the second channel 43. The separating cylinder 46 comprises a radially inward bounding surface of the annular flow channel 42 and a radially outward bounding surface of the annular flow channel 43. The first annular flow channel 42 is connected to the air inlet port 44 and the second annular flow channel 43 is connected to an anode exhaust exit port 45, so that a cathode air feed flow entering the reactant conditioning apparatus 2 through the air inlet port 44 will flow through the air preheater 41 in a counterflow direction to an anode exhaust flow exiting the conditioning apparatus 2 through the anode exhaust exit port 45. In some embodiments, the thermally conductive separating cylinder 46 includes heat transfer surface area enhancement features, such as, for example, a convoluted fin structure, extending into both annular flow channels 42 and 43 in order to increase the convective heat transfer between the flows in the channels. Such features have been excluded from the appended drawings for the sake of visual clarity.

The steam generator 34 is comprised of a helical coil 36 constructed of a thermally conductive material located within an annular flow channel 35. The helical coil assembly 36 is shown in greater detail in FIG. 7, and is comprised of an inlet 38, a plurality of first helical coils 87 comprising a first helical flow path connected to the inlet 38, a plurality of second helical coils 88 comprising a second helical flow path connected to the first helical flow path, and an outlet 39 connected the second helical flow path. It can be seen in FIG. 7 that the first and second helical flow paths are arranged so that each coil 87 of the first helical flow path will be adjacent to one or two coils 88 of the second helical flow path. Likewise, each coil 88 of the second helical flow path will be adjacent to one or two coils 87 of the first helical flow path, thereby allowing a flow to pass through the second helical flow path in a direction that is opposite to the direction the flow traveled in the first helical flow path, thereby allowing the inlet 38 and the outlet 39 to be located at the same end of the helical coil assembly 36. The annular flow channel 35 is connected to a cathode exhaust port 40, so that a cathode exhaust flow can pass through the annular flow channel 35, thereby passing over the helical coil assembly 36 and convectively transferring heat to a flow passing through the helical coil 36, prior to removal of the cathode exhaust flow from the reactant conditioning apparatus 2 through the cathode exhaust port 40.

During operation of the fuel cell system 1 the steam generator 34 can be used to produce a steam flow by delivering a water flow into the helical coil assembly 36 through the inlet 38, flowing the water in a first helical flow path through the plurality of first helical coils 87 wherein it receives a first quantity of heat from the cathode exhaust flow, flowing in a second helical flow path through the plurality of second helical coils 88 wherein it receives a second quantity of heat from the cathode exhaust flow, and exiting the helical coil assembly 36 through the outlet 39. In some embodiments, the sum of the first quantity of heat and the second quantity of heat exceeds the amount of heat required to fully vaporize the water flow so that the water flow exits the helical coil assembly 36 as a superheated steam flow.

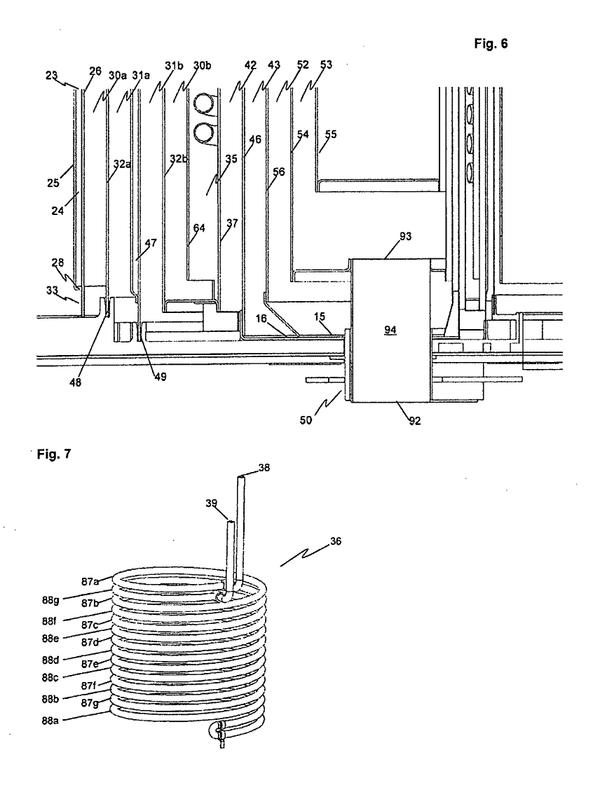

The cathode recuperator 29 is comprised of a plurality of first annular flow channels 30, a plurality of second annular flow channels 31, and a thermally conductive separating cylinder 32 located between each first annular flow channel 30 and adjacent second annular flow channel 31. While the embodiment depicted in FIGS. 5 and 6 shows the cathode recuperator 29 comprised of two annular channels 30, two annular channels 31 and two cylindrical separating cylinders 32, it should be understood that a cathode recuperator with a greater number of such channels and cylinders may be preferable in other embodiments depending on the amount of heat transfer required for the application. The embodiment as shown includes: a first thermally conductive separating cylinder 32a comprising the radially inward bounding surface of a first annular flow channel 30a, and the radially outward bounding surface of a second annular flow channel 31a. A second thermally conductive separating cylinder 32b comprises the radially outward bounding surface of a third annular flow channel 30b, and the radially inward bounding surface of a fourth annular flow channel 31b. The second thermally conductive cylinder 32b is located radially inward of the first thermally conductive cylinder 32a. The fourth annular flow channel 30b is connected to the first annular flow channel 30a and to the steam generator annular flow channel 35 so that a cathode exhaust flow passing through the steam generator 34 first passes through the cathode recuperator 29 by first flowing through the first channel 30a and second flowing through the fourth channel 30b. The third annular flow channel 31b is connected to the second annular flow channel 31a and to the air preheater annular flow channel 42 so that a cathode fresh air flow passing through the air preheater 41 will subsequently pass through the cathode recuperator 29 by first flowing through the third channel 31b and second flowing through the second channel 31a. The cathode fresh air flow and cathode exhaust flow pass through the cathode recuperator 29 in a counterflow arrangement. A radial cathode exhaust inlet opening 33 allows cathode exhaust surrounding the centrally located reactant conditioning apparatus 2 to enter the first annular flow channel 30a.

In the embodiment shown, a cylindrical wall 64 comprises the radially inward boundary of the fourth annular flow channel 30b of the cathode recuperator 29, and additionally comprises the radially outward boundary of the annular flow channel 35 of the steam generator 34.

The cathode recuperator 29 also includes a thermally non-conductive cylindrical separating wall 47 located between the second passage 31a and the third passage 31b in order to prevent unwanted heat transfer to occur between the flows passing through these channels. It should be understood that the thermally nonconductive cylindrical separating wall 47 can be produced by various methods, including but not limited to as a cylindrical wall comprised of a plurality of thermally conducting cylinders separated by a thermally non-conductive material, or as a single cylindrical cylinder made from a thermally non-conductive material such as a ceramic.

The nonconductive cylindrical separating wall 47 includes a cylindrical end portion 49 that is configured to seat into the second circular grooves 18 of the plurality of stack support modules 10. Additionally, the first thermally conductive cylinder 32a includes a cylindrical end portion 48 that is configured to seat into the first circular grooves 17 of the plurality of stack support modules 10, so that the second annular flow passage 31a is placed in fluid communication with the plurality of cathode air passages 11, thereby allowing a cathode fresh air flow passing through the cathode recuperator 29 to subsequently flow through the cathode air passages 11. In some embodiments, it may be desirable to provide a fluid seal at the junction of the cylindrical end portion 48 and the first circular grooves 17 and/or at the junction of the cylindrical end portion 49 and the second circular grooves 18, for example by welding, caulking, or any other known methods of achieving a high-temperature fluid seal.

In some embodiments, the thermally conductive separating cylinders 32 can have heat transfer surface area enhancement features, such as for example a convoluted fin structure, extending into the annular flow channels 30 and 31 in order to increase the convective heat transfer between the flows in the channels. Such features have been excluded from the appended drawings for the sake of visual clarity.

The startup oxidizer 22 is comprised of an annular flow channel 23 bounded by an outer cylindrical wall 25 and an inner cylindrical wall 26. The startup oxidizer 22 is further comprised of a corrugated sheet 24 located within the annular flow channel 23, wherein the surfaces of the corrugated sheet 24 have been coated with a catalyst suitable for oxidizing a mixture comprising air and one or more combustible species, including but not limited to hydrogen, carbon monoxide and methane. The startup oxidizer 22 is configured to receive a combustible flow at the top of the annular flow channel 23, oxidize the combustible flow by passing it over the catalyst-coated corrugated sheet 24, reject the heat released by the oxidation by radiation from the outward-facing cylindrical surface 27 of the outer cylindrical wall 25, and exhaust the oxidized flow through an annular opening 28 at the bottom of the annular flow channel 23.

During startup of the fuel cell system 1, the startup oxidizer 22 can be used to heat the fuel cell stacks 4 to operating temperature by radiating heat from the outward facing cylindrical surface 27 to the fuel cell stacks 4 arranged around the centrally located reactant conditioning apparatus 2. It should be observed that during such operation, the cathode exhaust flowing into the cathode recuperator 29 through the radial cathode exhaust inlet opening 33 will comprise the startup oxidizer exhaust flow exiting the annular opening 28.

The ATO 50 is comprised of a porous cylindrical monolith 94 with an inlet face 92 and an exit face 93. The monolith 94 has internal surfaces coated with a catalyst suitable for oxidizing a flow comprising air and one or more combustible species, including but not limited to hydrogen, carbon monoxide and methane. During operation of the fuel cell system 1 the ATO 50 receives a combustible mixture comprising air and anode exhaust, catalytically oxidizes the mixture as it passes through the catalyst coated porous cylindrical monolith 94, and exhausts the flow as an ATO exhaust flow from the exit face 93.

The anode feed preconditioning heat exchanger 51 is comprised of a first annular flow channel 52, a second annular flow channel 53 located concentric to and radially inward from the first annular flow channel 52, and a thermally conductive separating cylinder 54 located between the first channel 52 and the second channel 53. The separating cylinder 54 comprises a radially inward bounding surface of the first annular flow channel 52 and a radially outward bounding surface of the second annular flow channel 53. The heat exchanger 51 is further comprised of a cylindrical wall 56 with a radially outward bounding surface of the first annular flow channel 52, and a cylindrical wall 55 comprising the radially inward bounding surface of the second annular flow channel 53. The first annular flow channel 52 is connected to the anode feed inlet port 57 and the second annular flow channel 53 is connected at a first end to the ATO exit 93 and at a second end to an ATO exhaust port 58 on the centrally located reactant conditioning apparatus, so that an anode feed flow entering the reactant conditioning apparatus 2 through the anode feed inlet port 57 will flow through the anode feed preconditioning heat exchanger 51 in a counterflow direction to an ATO exhaust flowing through the anode feed preconditioning heat exchanger 51 from the ATO exit 53 to the ATO exhaust port 58.

In some embodiments, the thermally conductive separating cylinder 54 can have heat transfer surface area enhancement features, such as, for example, a convoluted fin structure, extending into both annular flow channels 52 and 53 in order to increase the convective heat transfer between the flows in the channels. Such features have been excluded from the appended drawings for the sake of visual clarity. In some embodiments, a portion of a heat transfer surface area enhancement feature located within the first annular flow channel 52 can be coated with a steam reforming catalyst in order to perform some partial reforming of hydrocarbon species in the anode feed flow.

The anode recuperator 59 is comprised of a first annular flow channel 43, a second annular flow channel 52 located concentric to and radially inward from the first annular flow channel 43, and a thermally conductive separating cylinder 56 located between the first channel 43 and the second channel 52. The separating cylinder 56 also comprises a radially inward bounding surface of the first annular flow channel 43 and a radially outward bounding surface of the second annular flow channel 52. The anode recuperator 59 is located downstream of the anode feed preconditioning heat exchanger 51 and upstream of the air preheater 41, so that an anode feed flowing through the annular flow channel 52 will first pass through the anode feed preconditioning heat exchanger 51 and second pass through the anode recuperator 59, and an anode exhaust flowing through the annular flow channel 43 will first pass through the anode recuperator 59 in a counterflow direction to the anode feed and second pass through the air preheater 41.

The anode recuperator 59 is further comprised of a cylindrical wall 54 comprising the radially inward bounding surface of the annular flow channel 52, and a cylindrical wall 46 comprising the radially outward bounding surface of the annular flow channel 43. The annular flow channel 52 is in fluid communication with the manifold inlet ports 15 of the plurality of stack support modules 10, so that an anode feed flowing through the annular flow channel 52 is able to flow into the manifold inlet ports 15. Additionally, the annular flow channel 43 is in fluid communication with the manifold exit ports 16 of the plurality of stack support modules 10, so that an anode exhaust is able to flow from the manifold exit ports 16 into the annular flow channel 43.

In some embodiments, the thermally conductive separating cylinder 56 can have heat transfer surface area enhancement features, such as for example a convoluted fin structure, extending into both annular flow channels 52 and 43 in order to increase the convective heat transfer between the flows in the channels. Such features have been excluded from the appended drawings for the sake of visual clarity.

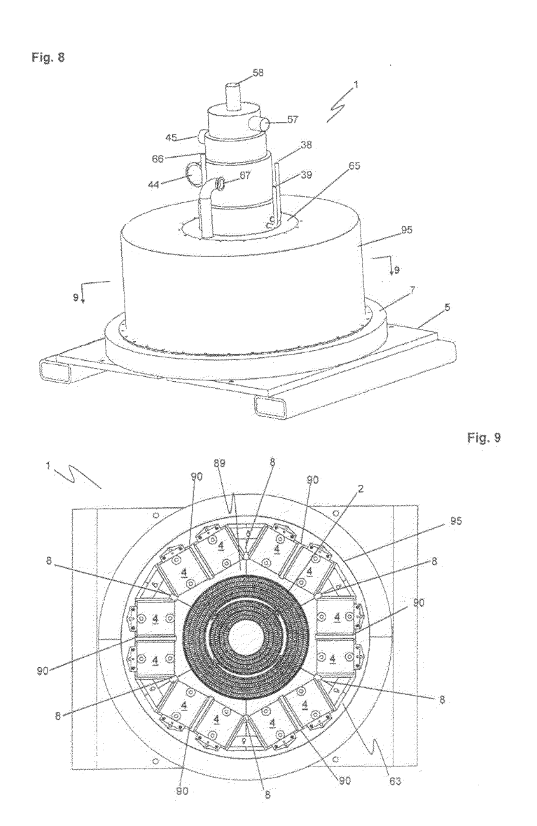

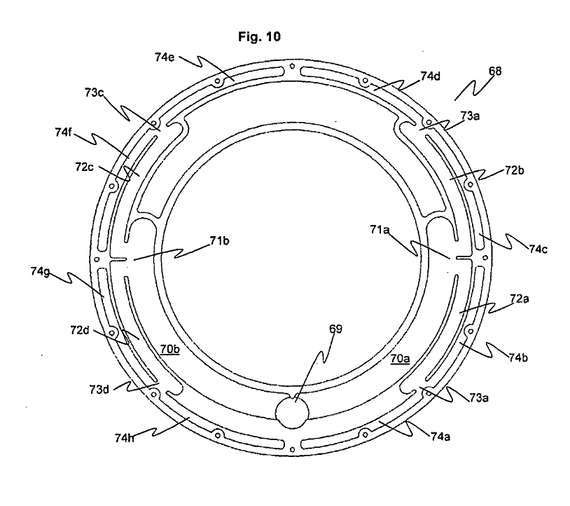

The centrally located reactant conditioning apparatus 2 is additionally comprised of an outer shell upper mounting surface 65, located between the radiating cylindrical surface 20 and the reactant inlets and outlets 38, 39, 40, 44, 45, 57 and 58. As shown in FIGS. 8 and 9, the fuel cell system 1 includes an outer shell 95 that connects to the high temperature sealing surface 6 and to the outer shell upper mounting surface 65, the outer shell enclosing the fuel cell stacks 4 and a portion of the reactant conditioning apparatus 2. In some embodiments, as shown in FIG. 9, a plurality of first air baffles 8 between non-parallel adjacent stacks 4 and a plurality of second air baffles 90 between parallel adjacent stacks 4 can be used to create a cathode air inlet plenum 63 between the stacks 4 and the outer shell 95. The plenum 63 is open to the plurality of cathode air passage exits 19 in the plurality of stack support modules 10 in order to receive a cathode air flow therefrom. The plenum 63 is additionally open to a plurality of externally manifolded cathode passage inlets within the fuel cell stacks 4 in order to deliver a cathode air flow thereto. Similarly, a cathode exhaust plenum 89 is created between the fuel cell stacks 4 and the centrally located reactant conditioning apparatus 2. The plenum 89 is open to a plurality of externally manifolded cathode passage exits within the fuel cell stacks 4 in order to receive a cathode exhaust flow therefrom. The plenum 89 is additionally open to the startup oxidizer annular opening 28 to receive a startup exhaust flow therefrom, and to the cathode recuperator radial cathode exhaust inlet opening 33 to deliver the exhaust flow thereto. In some embodiments wherein the stacks 4 have internally manifolded cathode air inlets, the cathode air inlet plenum 63 is not necessary and can be eliminated by not including the baffles 8 and 90, whereby the exhaust plenum 89 surrounds the stacks and is bounded by the outer enclosure 95.

A flow distribution manifold 68 is provided in the reactant conditioning apparatus 2 for the purpose of delivering a uniformly distributed combustible mixture to the startup oxidizer 22. As indicated in FIG. 5, the flow distribution manifold 68 is located directly underneath the outer shell upper mounting surface 65, and is configured to receive a combustible flow comprising a fuel flow delivered through startup oxidizer fuel inlet port 66 and further comprising an air flow delivered through startup oxidizer air inlet port 67 (best seen in FIG. 8). The combustible flow is delivered to the startup oxidizer annular flow channel 23 by the flow distribution manifold 68. In some embodiments, the combustible flow is delivered to channel 23 with a highly uniform distribution of the flow in the channel in order to provide a spatially uniform rate of radiative heating from the radiating surface 27 during startup of the fuel cell system 1.

It is known to those skilled in the art of combustion science that when a combustible mixture is flowing in a region where the temperature is sufficiently high such that the mixture is within its flammability limits, then the flow velocity of the mixture should be maintained at a magnitude greater than the laminar flame speed of the mixture in order to avoid pre-ignition of the combustible mixture. Since the flow distribution manifold is located within the high temperature region of the fuel cell system 1, the combustible flow that is delivered to the startup oxidizer 22 can be within its flammability limits as it passes through the distribution manifold 68. Some embodiments of the invention therefore include a distribution manifold 68 that accomplishes the uniform distribution of the combustible flow to the annular flow channel 23 while maintaining the flow velocity at a sufficiently high magnitude to avoid pre-ignition of the combustible flow.

With reference to FIG. 10 the startup oxidizer flow distribution manifold 68 of the preferred embodiment will be explained in greater detail. The combustible flow mixture enters the flow distribution manifold 68 through an inlet port 69 and is delivered to a pair of first flow channels 70. The pair of first channels 70 are symmetric around the inlet port 69, so that an approximately equal portion of the combustible flow will be passed to each of the channels 70. The first flow channels each describe a circular path traversing approximately a 90° arc from the inlet port 69 to a first flow channel exit 71, such that one of the first flow channels 70a defines a circular path in a first angular direction from the inlet port 69 to an exit 71a and the other of the first flow channels 70b describes a circular path in a second angular direction from the inlet port 69 to an exit 71b, wherein the second angular direction is opposite to the first angular direction so that the one of the first exits 71a is located directly opposite the other of the first exits 71b.

Each of the first flow channel exits 71 is connected to a pair of second flow channels 72. The second flow channels 72 each describe a circular path traversing approximately a 45° arc located radially outward of the first flow channels 70 and each ending in one of a plurality of second channel exits 73. Each one of the second flow channels 72 is connected to a common first channel exit 71 and travels in an angular direction opposite that of the other of the second flow channels 72 connected to the same first channel exit 71. As a result, the plurality of second flow channel exits 73 are located at a common radial distance from the center of the reactant conditioning apparatus 2 with an angular spacing of approximately 90° between adjacent exits 73.

Each of the second flow channel exits 73 is connected to a pair of third flow channels 74. The third flow channels 74 each describe a circular path traversing approximately a 22.5° arc located radially outward of the second flow channels 72. Each one of the third flow channels 74 is connected to a common second channel exit 73 and travels in an angular direction opposite that of the other of the third flow channels 74 connected to the same second channel exit 73. As a result, the plurality of third flow channels 74 are located along the outer periphery of the flow distribution manifold 68 and span approximately the entire circumference of the flow distribution manifold 68.

In some embodiments, the radial location and width of the third flow channels 74 is approximately the same as the width and radial location of the startup oxidizer annular flow channel 23. Accordingly, the combustible flow can directly pass from the third flow channels 74 into the annular flow channel 23. In some embodiments, the flow can pass through a pressure drop inducing device, such as, for example, a plurality of small holes, as it passes from the third flow channels 74 into the annular flow channel 23 in order to further optimize the uniformity of flow distribution in the annular flow channel 23. In some embodiments, the sum of the flow areas of the first flow channels 70, the sum of the flow areas of the second flow channels 72 and the sum of the flow areas of the third flow channels 74 are all approximately equal, so that the velocity of the combustible mixture is kept essentially constant as it flows through the distribution manifold 68. In some embodiments, the resulting velocity of the combustible mixture passing through the distribution manifold 68 is sufficiently high to avoid pre-ignition of the combustible mixture.

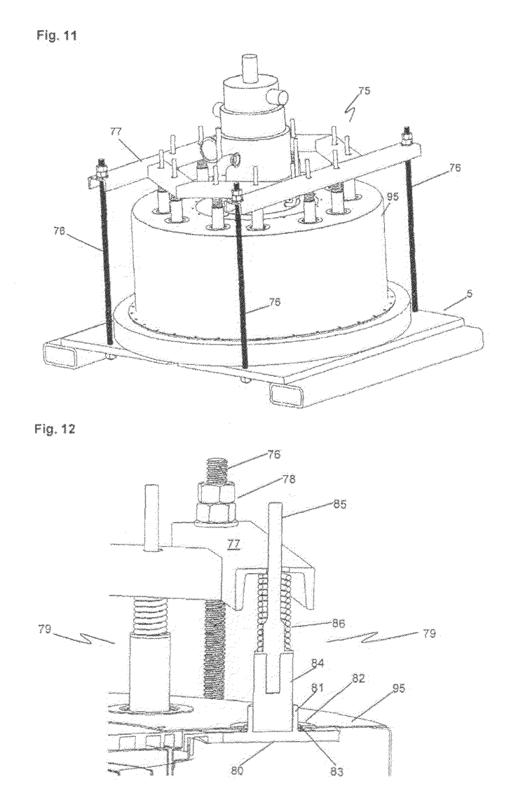

In some embodiments, it can desirable to maintain a compressive load on the fuel cell stacks 4 in order to prevent leakage of the reactants between adjacent cells in the stacks. FIGS. 11 and 12 show an embodiment of the present invention with a compression mechanism 75 capable of maintaining such a compressive load on the fuel cell stacks 4. The compression mechanism 75 is comprised of a plurality of tie rods 76 and threaded fasteners 78, a load frame 77, and a plurality of single stack compression modules 79. One module 79 can be located on top of each fuel cell stack 4 to deliver a compressive load thereto. A first end of each of the tie rods 76 is fastened to the low-temperature support base 5. A second end of each of the tie rods 76 passes through holes in the load frame 77, and threaded fasteners 78 are attached to the tie rods 76 above the load frame 77 so that an upward acting force on the load frame 77 will result in a counter-acting tensile load in the tie rods 76.

Each single stack compression module 79 is comprised of a pressure plate 80 with integral collar 81, a high-temperature gasket 83, a gasket retaining ring 82, a thermally insulating standoff 84, a guide pin 85, and a compression spring 86. The pressure plate 80 is located on top of one of the fuel cell stacks 4. The pressure plate 80 can be comprised of a material that is capable of withstanding compressive loading with minimal deformation, such as, for example, a metallic alloy. In some embodiments, a layer of non-conductive and/or compliant material can be positioned between the pressure plate 80 and the top of the fuel cell stack 4. In the embodiment shown the outer shell 95 includes a plurality of holes to enable each of the integral collars 81 to pass through the outer shell 95.

A high-temperature gasket 83 can be provided for each stack compression module 79 to prevent leakage of air through the holes from the interior of the outer shell 95. In some embodiments, the gasket 83 can be comprised of a thin metal foil. In other embodiments, the gasket 83 can be comprised of a ceramic. A gasket retaining ring 82 is provided for each stack compression module 79, and is attached to the outer shell 95 in order to prevent the gasket 83 from lifting off of the outer shell 95. In some embodiments, the gaskets 83 are free to translate some amount within a plane parallel to the top surface of the outer shell 95, so that the gasket seal can be maintained as the parts move relative to one another due to thermal expansion.

A thermally insulating standoff 84 prevents excessive heat leakage by minimizing the thermal conduction path from the fuel cell stacks 4 to the compression module 79. The thermally insulating standoff 84 can be comprised of a material that combines low thermal conductivity with high compressive strength, such as for example a high-density alumina.

A guide pin 85 provides ease of location for the load frame 77, maintains alignment of the compression spring 86, and provides a hardened bearing surface for the compression spring 85. In some embodiments, the guide pin 85 and the thermally insulating standoff 84 may be combined into a single component. The compression spring 86 is located between the load frame 77 and a bearing surface of the guide pin 85. In operation, a compressive load can be applied to the fuel cell stacks 4 by placing the load frame 77 at a location relative to the single stack compression modules such that the distance between the spring bearing surfaces of the load frame 77 and the spring bearing surfaces of the guide pins 85 is less than the free length of the compression springs 86, and locating the threaded fasteners 78 so that the location of the load frame 77 is maintained. This results in a compression of the springs 86, the resulting force of which is resisted by a tensile loading of the tie rods 76, thereby resulting in a compressive loading of the fuel cell stacks 4.

The embodiments described above and illustrated in the figures are presented by way of example only and are not intended as a limitation upon the concepts and principles of the present invention. As such, it will be appreciated by one having ordinary skill in the art that various changes are possible.

What is claimed is:

1. A fuel cell system comprising:
a support structure;
a reactant conditioning structure;
a plurality of stacks of planar solid oxide fuel cells arranged on the support structure circumferentially around the reactant conditioning structure;
a first flow path extending outwardly from the reactant conditioning structure to transfer a first reactant between the reactant conditioning structure and the plurality of stacks; and
a second flow path extending outwardly from the reactant conditioning structure to transfer a second reactant between the reactant conditioning structure and the plurality of stacks, the first reactant being different from the second reactant.

2. The fuel cell system of claim 1, wherein the support structure includes a manifold supporting at least one of the plurality of stacks thereon, and wherein the manifold includes
a face for supporting the at least one of the plurality of stacks, and
a flow inlet and a flow outlet extending through the face, the flow inlet and the flow outlet oriented to connect the first flow path to the at least one of the plurality of fuel cell stacks.

3. The fuel cell system of claim 2, wherein the face for supporting the at least one of the plurality of stacks is a first face, and wherein the manifold further includes a second face opposite to the first face, the second face defining an anode feed plenum and an anode exhaust plenum.

4. The fuel cell system of claim 3, wherein at least a portion of the anode feed plenum is substantially parallel to at least a portion of the anode exhaust plenum.

5. The fuel cell system of claim 3, wherein the manifold further includes a cathode plenum defined between the first face and the second face.

6. The fuel cell system of claim 1, wherein the support structure includes a manifold supporting at least one of the plurality of stacks thereon, wherein the manifold defines a first flow path and a second flow path, and wherein at least a portion of the first flow path flows in a first direction orthogonal to a second direction defined by at least a portion of the flow of the second flow path.

7. The fuel cell system of claim 6, wherein the first flow path of the manifold includes the cathode flow path and the second flow path of the manifold includes an anode flow path.

8. The fuel cell system of claim 1, wherein the support structure includes a manifold supporting at least one of the plurality of stacks thereon, and wherein the manifold includes a groove oriented to receive a heat exchange surface of the reactant conditioning structure, the manifold and the heat exchange surface defining the second flow path and a third flow path in heat exchange relationship with the second flow path and extending away from the manifold.

9. The fuel cell system of claim 1, wherein the support structure includes a manifold supporting at least one of the plurality of stacks thereon, and wherein the manifold at least partially defines the first flow path for connecting the reactant conditioning structure to the plurality of stacks.

10. A fuel cell system comprising:
a support structure;
a reactant conditioning structure;
a plurality of stacks of planar solid oxide fuel cells arranged on the support structure circumferentially around the reactant conditioning structure; and
a flow path extending outwardly from the reactant conditioning structure to transfer a reactant between the reactant conditioning structure and the plurality of stacks;
wherein the support structure includes a wedge shaped manifold supporting at least one of the plurality of stacks thereon.

11. The fuel cell system of claim 10, wherein the manifold includes
a first face for supporting a plurality of planar solid oxide fuel cells;
a second face opposite to the first face, the second face at least partially defining an anode feed plenum and an anode exhaust plenum;
an anode feed inlet extending between the first face and the second face and being fluidly connected to one end of the anode feed plenum;
an anode flow outlet extending between the first face and the second face and being connected to one end of the anode exhaust plenum;
a plenum inlet fluidly connected to another end of the anode feed plenum; and
a plenum outlet fluidly connected to another end of the anode exhaust plenum.

12. A manifold of a fuel cell system, the manifold comprising:
a first face for supporting a plurality of planar solid oxide fuel cells;
a second face opposite to the first face, the second face at least partially defining an anode feed plenum and an anode exhaust plenum;
an anode feed inlet extending between the first face and the second face and being fluidly connected to one end of the anode feed plenum;
an anode flow outlet extending between the first face and the second face and being connected to one end of the anode exhaust plenum;
a plenum inlet fluidly connected to another end of the anode feed plenum;
a plenum outlet fluidly connected to another end of the anode exhaust plenum; and
a cathode flow inlet opening through an exterior edge of the manifold to direct cathode air towards the plurality of planar solid oxide fuel cells, the exterior edge extending between the first surface and the second surface.

13. The manifold of claim 12, further comprising a groove extending across the first face between the anode feed inlet and the plenum outlet, wherein the groove is oriented to receive a heat exchange surface of the fuel cell system, such that the manifold and the heat exchange surface define a flow path fluidly connected to the manifold.

14. A fuel cell system comprising:
a fuel cell stack support structure; and
a reactant conditioning apparatus to condition anode and cathode reactants within to a temperature and composition for optimal reaction within a plurality of solid oxide fuel cell stacks supported on the fuel cell stack support structure;
wherein the plurality of fuel cell stacks are in fluid communication with the reactant conditioning apparatus to direct preconditioned anode and cathode reactants to the fuel cell stacks and direct cathode and anode exhaust from the fuel cell stacks to the conditioning apparatus, and
wherein the fuel cell stacks surround the conditioning apparatus.

15. The fuel cell system of claim 14, wherein the reactant conditioning apparatus includes at least two of an anode tailgas oxidizer, an anode feed preconditioning heat exchanger, an anode recuperator, an air preheater, a steam generator, a cathode recuperator, and a startup oxidizer.

16. The fuel cell system of claim 15, wherein the at least two of an anode tailgas oxidizer, an anode feed preconditioning heat exchanger, an anode recuperator, an air preheater, a steam generator, a cathode recuperator, and a startup oxidizer are concentric with respect to a central axis defined by the conditioning apparatus.

17. The fuel cell system of claim 14, wherein the reactant conditioning apparatus is located in a substantially concentric manner with respect to a central axis defined by the conditioning apparatus.

18. The fuel cell system of claim 14, wherein the conditioning apparatus includes a first wall defining a first fluid path and a second fluid path opposite to the first fluid path, and wherein the first fluid path and the second fluid path are concentric.

19. The fuel cell system of claim 18, wherein the first fluid path receives an exhaust from an oxidizer.

20. The fuel cell system of claim 15, wherein the conditioning apparatus includes a first flow path with an upstream portion defining a pass through an anode feed preconditioning heat exchanger and a downstream portion defining a pass through an anode recuperator, and wherein the conditioning apparatus includes a second flow path in heat exchange relation with the first flow path and having an upstream portion defining a pass through another recuperator and a downstream portion defining a pass through an air preheater.

21. The fuel cell system of claim 20, wherein a flow along the first flow path travels in a first direction and the second flow path travels in a second direction opposite to the first direction, and wherein the first flow path is concentric with the second flow path with respect to an axis defined by the conditioning apparatus.

22. The fuel cell system of claim 21, wherein the first flow path is positioned inwardly from the second flow path with respect to the axis.

23. A fuel cell system comprising:
a support structure;
a reactant conditioning apparatus mounted on the support structure and including at least two of an anode tailgas oxidizer, an anode feed preconditioning heat exchanger, an anode recuperator, an air preheater, a steam generator, a cathode recuperator, and a startup oxidizer;
a plurality of cells supported on the structure so as to be removeable without disconnecting the elements of the conditioning apparatus; and
a removable cover operable to enclose the plurality of cells and at least a portion of the conditioning apparatus.

24. The fuel cell system of claim 23, wherein the plurality of cells surround the conditioning apparatus.

25. The fuel cell system of claim 23, wherein the conditioning apparatus is positioned centrally on the support structure with respect to an axis extending through the fuel cell system.

26. The fuel cell system of claim 23, further comprising a compression mechanism cooperating with the removable cover to bias at least one of the plurality of cells toward the support structure.
